(19) United States
(12) Patent Application Publication
(10) Pub. No.: US 2004/0183430 A1
(43) Pub. Date: Sep. 23, 2004

(54) Image display device

(76) Inventors: Shigeo Takenaka, Fukaya-shi (JP); Masaru Nikaido, Yokosuka-shi (JP); Satoshi Ishikawa, Kukaya-shi (JP); Sachiko Hirahara, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/809,718

(22) Filed: Mar. 26, 2004

Related U.S. Application Data
(63) Continuation of application No. PCT/JP02/09971, filed on Sep. 26, 2003.

(30) Foreign Application Priority Data
Sep. 27, 2001 (JP) 2001-297046

(51) Int. Cl. H01J 1/62; H01J 63/04; G09G 3/10; H01J 1/02

(52) U.S. Cl. 313/495; 313/497; 315/169.2

(57) ABSTRACT

An image display device comprises a faceplate having an image display surface and a rear plate opposed to the faceplate across a gap and having a plurality of electron sources which excite the image display surface. A grid and a plurality of spacers which maintain the space between the plates are provided between the faceplate and the rear plate. A voltage from a voltage supply unit that is higher than a voltage applied to the faceplate is applied to the grid, so that electric discharge can never be caused directly between the faceplate and the rear plate.

### CROSS-REFERENCE TO RELATED APPLICATIONS

This is a Continuation Application of PCT application No. PCT/JP02/09971, filed Sep. 26, 2002, which was not published under PCT Article 21(2) in English.

This application is based upon and claims the benefit of priority from the prior Japanese Patent Application No. 2001-297046, filed Sep. 27, 2001, the entire contents of which are incorporated herein by reference.

### BACKGROUND OF THE INVENTION

1. Field of the Invention

This invention relates to an image display device in which a substrate formed having a phosphor screen and a substrate having a plurality of electron sources thereon are opposed to each other.

2. Description of the Related Art

In recent years, there have been demands for image display devices for high-grade broadcasting or high-resolution versions therefor, which require higher screen display performance. To meet these demands, the screen surface must be flattened and enhanced in resolution. At the same time, the devices must be lightened in weight and thinned.

Flat image display devices, such as a field-emission display (hereinafter referred to as FED), have been noted as image display devices that meet the aforesaid demands. The FED has a faceplate and a rear plate that are opposed to each other with a fixed gap between them. These substrates have their respective peripheral edge portions joined together directly or via a sidewall in the form of a rectangular frame, and constitute a vacuum envelope. A phosphor screen is formed on the inner surface of the faceplate, while a plurality of electron emitting elements, for use as electron sources that excite a phosphor to light emission, are arranged on the inner surface of the rear plate.

Further, a plurality of support members are arranged between the rear plate and the faceplate in order to support an atmospheric load that acts on these substrates. In this FED, moreover, electron beams that are emitted from the electron emitting elements are applied to the phosphor screen so that an image is displayed when the phosphor screen glows.

According to this FED, the size of each electron emitting element is of the micrometer order, and the distance between the faceplate and the rear plate can be set in the millimeter order. Thus, the device, compared with a cathode-ray tube or the like that is used as a display of an existing TV or computer, can enjoy higher resolution, lighter weight, and reduced thickness.

In order to obtain practical display characteristics for the image display device described above, a phosphor that resembles that of a conventional cathode-ray tube is used, and its anode voltage must be set to several kilovolts or more, and preferably to 10 kV or more. In view of the resolution, the properties and productivity of the support members, etc., the gap between the faceplate and the rear plate cannot be made very wide and should be set to about 1 to 3 mm. Inevitably, therefore, a high-intensity electric field is formed between the faceplate and the rear plate, raising a problem that electric discharge (dielectric breakdown) occurs between the two substrates.

If electric discharge is caused, the electron emitting elements and phosphor layers-on the substrates may possibly be damaged or decayed, which lowers the display quality level. The electric discharge that results in such a failure is unfavorable for a product. It is necessary, therefore, to furnish the faceplate or the rear plate with a voltage-proof structure for preventing electric discharge or a discharge current lowering structure that keeps a discharge path at high impedance. However, neither of these structures can produce a satisfactory effect, and lowering of the display performance and increase in manufacturing cost are unavoidable.

### BRIEF SUMMARY OF THE INVENTION

This invention has been made in consideration of these circumstances, and its object is to provide an image display device capable of ensuring high dielectric strength against electric discharge, and an improved image quality level.

In order to achieve the above object, an image display device according to this invention comprises: a first substrate having a phosphor screen; a second substrate opposed to the first substrate across a gap and having a plurality of electron sources which emit electron beams to excite the phosphor screen; a grid provided between the first and second substrates and having a plurality of apertures opposed to the electron sources, individually; a plurality of spacers which maintain the space between the first substrate and the second substrate; and a voltage supply unit which applies a voltage to the first substrate and applies a voltage higher than the one for the first substrate to the grid.

According to the image display device constructed in this manner, the voltage applied to the grid is made a little higher than the voltage applied to the first substrate. If any electric discharge occurs, therefore, this discharge is produced between the grid and the second substrate, and no electric discharge can be caused directly between the first substrate and the second substrate. Since the grid has a high resistance value moreover, discharge current that is attributable to electric discharge is suppressed, so that the electron sources for the second substrate can be prevented from being damaged. Further, the potential difference between the grid and the first substrate that is produced in the aforesaid configuration is so small that it does not cause electric discharge between the grid and the first substrate. In consequence, voltage-proof structures for the first substrate and the second substrate can be obviated or simplified, so that the manufacturing cost can be reduced.

Since the grid has a high potential, scattered electrons that run against and are reflected by the first substrate are absorbed by the grid. Accordingly, the scattered electrons never run against the first substrate again, so that the contrast of displayed images can be improved. For the same reason, moreover, the spacers that are set up between the first substrate and the grid are charged less by the scattered electrons, so that surface treatment of the spacers for electrical conduction can be obviated or simplified.

Preferably, both faces of the grid and the inner surface of each aperture are subjected to a high-resistance surface treatment. In this case, discharge current that may be produced by electric discharge is suppressed, so that the electron sources for the second substrate can be prevented from being damaged.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an image display device according to an embodiment of this invention;

FIG. 2 is a perspective view of the image display device cut away along line II-II of FIG. 1;

FIG. 3 is an enlarged sectional view of the image display device;

FIG. 4 is a side showing a part of a spacer assembly formed in manufacturing processes for the image display device;

FIG. 5 is a sectional view showing a process of forming a high-resistance film on a second spacer of the spacer assembly, out of the aforesaid manufacturing processes; and

FIG. 6 is a sectional view schematically showing a process of joining a faceplate, the spacer assembly, and a rear plate together, as one of the aforesaid manufacturing processes.

### DETAILED DESCRIPTION OF THE INVENTION

An embodiment in which this invention is applied to a flat image display device (hereinafter referred to as SED) that uses electron emission sources of the surface-conduction type will be described in detail.

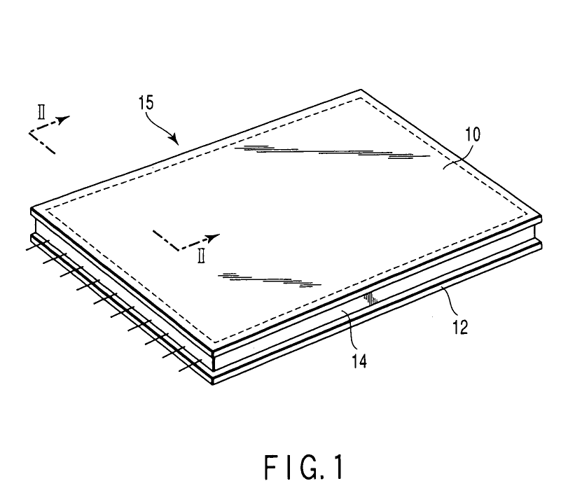

As shown in FIGS. 1 to 3, the SED comprises a faceplate 10 and a rear plate 12 as transparent insulating substrates, which are formed of rectangular glass plates, individually. These plates are opposed to each other with a gap of about 1.0 to 3.0 mm between them. The rear plate 12 is a little larger than the faceplate 10. The rear plate 12 and the faceplate 10 have their respective peripheral edge portions joined together by means of a glass sidewall 14 in the form of a rectangular frame, and constitute a flat, rectangular vacuum envelope 15.

A phosphor screen 16 is formed on the inner surface of the faceplate 10 that serves as a first substrate. The phosphor screen 16 is formed by arranging red, blue, and green phosphor layers and black non-luminous layers side by side. These phosphor layers are in the form of stripes or dots. Further, a metal back 17 of aluminum or the like is formed on the phosphor screen 16, which serves as an image display surface. A transparent electrically conductive film or color filter film of, for example, ITO, ATO, or “Nesa” (SnO₂) may be provided between the faceplate 10 and the phosphor screen.

A number of electron emitting elements 18 are arranged on the inner surface of the rear plate 12 that serves as a second substrate. They individually emit electron beams as electron sources that excite the phosphor layers of the phosphor screen 16. These electron emitting elements 18 are arranged in a plurality of columns and a plurality of rows corresponding to individual pixels. Each electron emitting element 18 is formed of an electron emitting portion (not shown), a pair of element electrodes that applies voltage to the electron emitting portion, etc. Further, a large number of wires (not shown) for applying voltage to the electron emitting elements 18 are formed in a matrix on the rear plate 12.

The sidewall 14 that serves as a joining member is sealed to the respective peripheral edge portions of the rear plate 12 and the faceplate 10 with a sealant 20 of, for example, low-melting glass or low-melting metal, and joins the faceplate and the rear plate together.

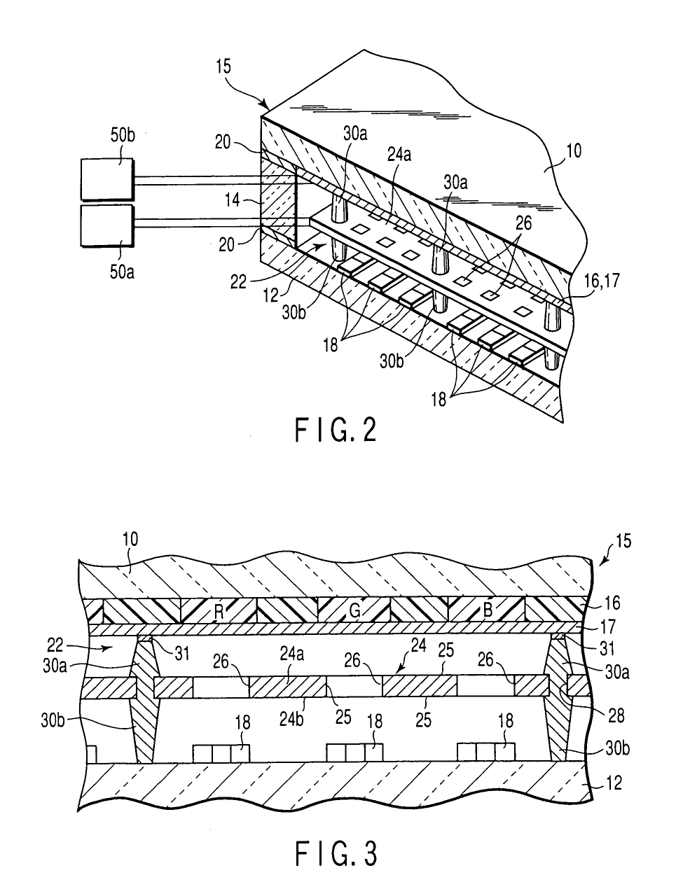

As shown in FIGS. 2 and 3, moreover, the SED comprises a spacer assembly 22 that is located between the rear plate 12 and the faceplate 10. In the present embodiment, the spacer assembly 22 is provided with a sheet-shaped grid 24 and a plurality of spacers that are set up integrally on the opposite sides of the grid.

More specifically, the grid 24 has a first surface 24a opposed to the inner surface of the faceplate 10 and a second surface 24b opposed to the inner surface of the rear plate 12, and is located parallel to those plates. A large number of electron beam passage apertures 26 and a plurality of spacer openings 28 are formed in the grid 24. The electron beam passage apertures 26 are arranged opposite the electron emitting elements 18, individually. The spacer openings 28 are located individually between the electron beam passage apertures and arranged at given pitches.

The grid 24 is formed of a metal sheet of, e.g., iron-nickel material with a thickness of 0.1 to 0.2 mm. An insulating film is formed on the surface of the grid 24 by, for example, spreading and burning low-melting glass. This insulating film may be an oxide film that is obtained by oxidizing the metal sheet.

A high-resistance film 25 having a discharge current limiting effect is superposed on the insulating film on the surface of the grid 24. The high-resistance film 25 is formed by, for example, spraying the grid 24 with a liquid in which tin oxide and antimony oxide particulates are dispersed and then drying and burning the grid. The resistance of the high-resistance film 25 is set to E+8 Ω/□ or more.

Further, each electron beam passage aperture 26 is in the form of a rectangle that measures 0.15 to 0.20 mm by 0.20 to 0.30 mm, and each spacer opening 28 has a diameter of about 0.2 to 0.3 mm. The aforesaid insulating layer and the high-resistance film 25 are also formed on the inner surface of each electron beam passage aperture 26.

A first spacer 30a is set up integrally on the first surface 24a of the grid 24, overlapping each corresponding spacer opening 28. The extended end of each first spacer 30a abuts against the inner surface of the faceplate 10 across the metal back 17 and the black non-luminous layers of the phosphor screen 16. In the present embodiment, the extended end of each first spacer 30a touches the metal back 17 across a height correcting layer 31. The height correction layer 31 corrects the dispersion of the height of each spacer. In view of the usability, for example, low-melting indium or its alloy is used as the height correcting layer. If the height accuracy of each spacer can be ensured satisfactorily, the height correcting layer 31 may be omitted.

A second spacer 30b is set up integrally on the second surface 24b of the grid 24, overlapping each corresponding spacer opening 28, and its extended end abuts against the inner surface of the rear plate 12. Each spacer opening 28 and the first and second spacers 30a and 30b are situated in line with one another, and the first and second spacers are coupled integrally to each other by means of the spacer opening 28.

Each of the first and second spacers 30a and 30b is tapered so that its diameter decreases from the side of the grid 24 toward the extended end.

For example, each first spacer 30a is formed so that the diameter of its proximal end on the side of the grid 24, the diameter of its extended end, and its height are about 0.4 mm, 0.3 mm, and 0.4 mm, respectively. Each second spacer 30b is formed so that the diameter of its proximal end on the side of the grid 24, the diameter of its extended end, and its height are about 0.4 mm, 0.25 mm, and 1.0 mm, respectively. Thus, the first spacers 30a are shorter to the second spacers 30b.

As mentioned before, the diameter of each spacer opening 28 ranges from about 0.2 to 0.3 mm, and is smaller than the diameter of the grid-side end of each of the first and second spacers 30a and 30b. Since the first spacer 30a and the second spacer 30b are arranged coaxially with the spacer opening 28 and provided integrally, the first and second spacers are coupled to each other through the spacer opening. Thus, they are formed integrally with the grid 24, holding the grid 24 from both sides.

A high-resistance film of, for example, tin oxide and antimony oxide is formed on the outer surface each second spacer 30b. Thus, the surface resistance of the second spacers 30b is lower than the surface resistance of the first spacers 30a.

As shown in FIGS. 2 and 3, the spacer assembly 22 constructed in this manner is located between the faceplate 10 and the rear plate 12. By abutting against the respective inner surfaces of the faceplate 10 and the rear plate 12, respectively, the first and second spacers 30a and 30b support an atmospheric load that acts on these plates, thereby keeping the distance between the plates at a given value.

Further, a given voltage is applied to the grid 24 in the manner mentioned later. An electron beam that is emitted from the electron emitting element 18 corresponding to each electron beam passage aperture 26 passes through the electron beam passage aperture and runs against its corresponding phosphor layer. Thus, the phosphor layer is excited to glow and display a desired image.

As shown in FIG. 2, the SED is provided with voltage supply units 50a and 50b that applies voltage to the grid 24 and the metal back 17 of the faceplate 10, respectively. The voltage supply unit 50a is connected to the grid 24 and applies voltage of, for example, 12 kV to the grid 24. The voltage supply unit 50b is connected to the metal back 17 and applies voltage of, for example, 10 kV to the metal back 17. Thus, the voltage that is applied to the grid 24 is set to be higher than the voltage that is applied to the faceplate 10. The voltage that is applied to the grid 24 is within 1.5 times, and preferably 1.25 times, as high as the voltage that is applied to the faceplate 10.

The following is a description of a manufacturing method for the spacer assembly 22 constructed in this manner and the SED provided with the same.

In manufacturing the spacer assembly 22, the grid 24 with given dimensions and first and second rectangular dies (not shown) that have substantially the same dimensions as those of the grid are prepared first. The grid 24 is previously formed having the electron beam passage apertures 26 and the spacer openings 28 shown in FIG. 3. Further, the whole grid 24 is oxidized, whereby an insulating film is formed on the grid surface that includes the respective inner surfaces of electron beam passage apertures 26 and the spacer openings 28. Furthermore, the insulating film is sprayed with the liquid in which tin oxide and antimony oxide particulates are dispersed, and is dried and burned to form the high-resistance film 25.

The first and second dies are formed having a plurality of through holes corresponding to the spacer openings 28 of the grid 24, individually. The first die is formed by laminating a plurality of or, for example, two thin metal sheets to each other. Each thin metal sheet is formed of an iron-nickel-based metal sheet with a thickness of 0.25 to 0.3 mm and has a plurality of tapered through holes. The through holes that are formed in each thin metal sheet have diameters different from those of the through holes that are formed in the other thin metal sheet. These two thin metal sheets are laminated to each other in a manner such that the through holes are arranged according to diameter, and are joined together by diffused junction in a vacuum or reducing atmosphere. Thus, the first die is formed having an overall thickness of 0.5 to 0.6 mm. Each through hole is defined by combining two through holes and has a stepped, tapered inner peripheral surface.

The second die, like the first die, is formed by laminating, for example, five thin metal sheets to one another. Each of the through holes that are formed in the second die is defined by five tapered through holes and has a stepped, tapered inner peripheral surface.

In the first and second dies, at least the inner peripheral surface of each through hole is coated with a resin that decomposes at a temperature lower than the decomposition temperature of an organic component of a spacer forming material, which will be mentioned later.

In manufacturing processes for the spacer assembly, the first die is brought intimately into contact with the first surface 24a of the grid so that the large-diameter side of each through hole is situated on the side of the grid 24, and is positioned so that each through hole is aligned with its corresponding spacer opening 28. Likewise, the second die is brought intimately into contact with the second surface 24b of the grid so that the large-diameter side of each through hole is situated on the side of the grid 24, and is positioned so that each through hole is aligned with its corresponding spacer opening 28. The first die, grid 24, and second die are fixed to one another by means of a clamper (not shown) or the like.

Then, the pasty spacer forming material is supplied from the outer surface side of the first die, whereby by the through holes of the first die, spacer openings 28 of the grid 24, and through holes of the second die are loaded with the spacer forming material. Glass paste that contains at least an ultraviolet-curing binder (organic component) and a glass filler is used as the spacer forming material.

Subsequently, ultraviolet (UV) rays as radiation are applied to the loaded spacer forming material from the outer surface side of the first and second dies, whereby the spacer forming material is UV-cured. If necessary, thermosetting may be used in combination to obtain a uniform effect characteristic in the depth direction.

Then, the first and second dies, kept intimately in contact with the grid, are kept at the decomposition temperature of the resin that is applied to the inner peripheral surface of each through hole 34 so that the resin is decomposed. Thus, a gap is formed between the spacer forming material and the inner peripheral surface of each through hole 34. Thereafter, the first and second dies and the grid 24 are cooled to a given temperature, and the first and second dies are then separated from the grid 24.

Subsequently, the grid, formed integrally with the spacer, is heat-treated in a heating oven to remove the binder from the spacer forming material. Thereafter, the spacer forming material is regularly burned at about 500 to 550° C. for about 30 minutes to one hour. Thus, by doing this, the base of the spacer assembly 22 is completed having the first and second built-in spacers 30a and 30b on the grid 24.

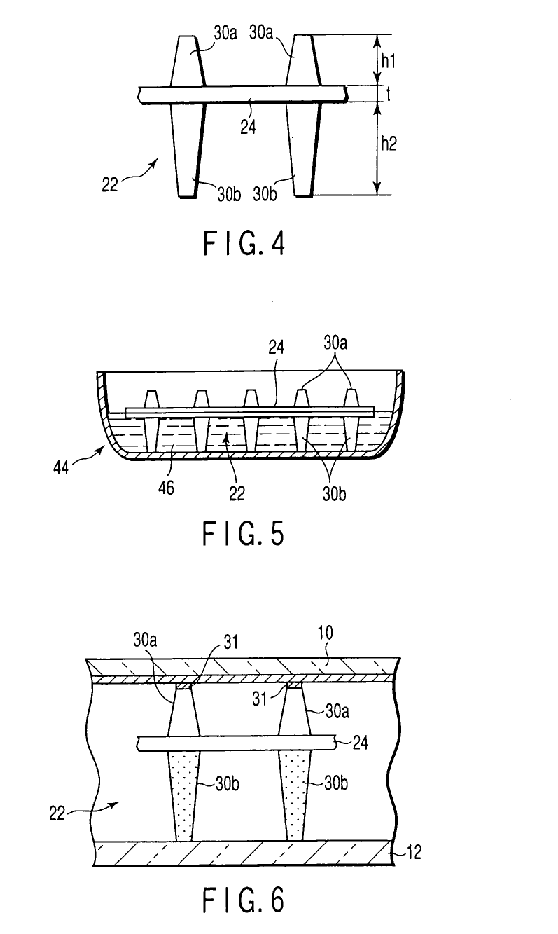

In the spacer assembly 22 formed in this manner, as shown in FIG. 4, the thickness of the grid 24 is 0.12 mm, and each first spacer 30a is formed so that the diameter of its proximal end on the side of the grid 24, the diameter of its extended end, and its height h1 are about 0.4 mm, 0.3 mm, and 0.4 mm, respectively. Each second spacer 30b is formed so that the diameter of its proximal end on the side of the grid 24, the diameter of its extended end, and its height h2 are about 0.4 mm, 0.25 mm, and 1.0 mm, respectively.

Subsequently, that part of the spacer assembly 22 which corresponds to the second spacers 30b is immersed in a coating fluid 46 in a polypropylene vessel 46, as shown in FIG. 5. The liquid in which tin oxide and antimony oxide particulates are dispersed is used as the coating fluid 46. After the spacer assembly 22 is drawn out of the vessel 46, it is dried and burned, whereupon a high-resistance film is formed on the surface of each second spacer 30b. Thus, in the spacer assembly 22, the surface resistance of the second spacers 30b is lower than the surface resistance of the first spacers 30a, and is set to E+8 to +9 Ω/□, for example. The spacer assembly 22 is completed by these processes.

In manufacturing the SED using the spacer assembly 22 manufactured in this manner, the rear plate 12 and the faceplate 10 are prepared beforehand. The rear plate 12 is provided in advance with the electron emitting elements 18 and joined with the sidewall 14. The faceplate 10 is provided in advance with the phosphor screen 16 and the metal back 17.

After paste that contains indium powder is applied to the extended end of each first spacer 30a, the spacer assembly 22 is positioned on the rear plate 12, as shown in FIG. 6. In this state, the rear plate 12 and the faceplate 10 are located in a vacuum chamber. After the vacuum chamber is evacuated, the faceplate 10 is joined to the rear plate 12 by means of the sidewall 14. At the same time, the indium powder is melted to bond the respective extended ends of the first spacers 30a and the faceplate 10 together. The SED having the spacer assembly 22 is manufactured in this manner.

According to the SED constructed in this manner, the grid 24 is provided between the faceplate 10 and the rear plate 12, and the voltage to be applied to the grid is set to be higher than the voltage to be applied to the faceplate. If any electric discharge occurs, therefore, this discharge is produced between the grid 24 and the rear plate 12, and no electric discharge can be caused directly between the faceplate 10 and the rear plate 12. Since the surface of the grid 24 is treated for high resistance, moreover, a very small discharge current is produced if electric discharge is caused. Therefore, the electron sources for the rear plate 12 cannot be damaged, so that a voltage-proof structure or discharge current lowering structure for the electron sources can be obviated or simplified.

If the potential of the grid 24 is raised, voltage is produced between the grid 24 and the faceplate 10. If the voltage difference is as small as about 2 kV, as in the case of the embodiment, however, electric discharge hardly occurs. If any electric discharge is caused, the discharge current is so small, owing to the effect of the high-resistance surface treatment of the grid 24, that it does not damage the phosphor screen 16 of the faceplate 10. Thus, a voltage-proof structure or discharge current lowering structure can be also obviated or simplified in the case of the faceplate 10. In consequence, the manufacturing cost of the whole SED can be reduced.

If the potential of the grid 24 is higher than the potential of the faceplate 10, electrons that run against and are reflected by the phosphor screen 16 of the faceplate 10 are absorbed by the grid 24, and run less frequently against the phosphor screen 16 again. Thus, undesired light emission can be reduced, and the contrast of displayed images can be improved. For the same reason, the reflected electrons from the phosphor screen 16 are reduced, so that the charging level of the spacers is lowered. Thus, displacement of the trajectory of the electron beams that is attributable to static electricity in the spacers is lessened, so that the color purity can be improved. At the same time, surface treatment of the first spacers for electrical conduction can be obviated or simplified.

Further, electric fields of the electron source surfaces can be intensified to improve the electron emission efficiency of the electron sources by raising the potential of the grid 24. Thus, the luminance of display images can be improved, and the power consumption can be reduced.

According to the SED constructed in this manner, the first spacers 30a on the side of the faceplate 10 made shorter than the second spacers 30b on the side of the rear plate 12. Therefore, the charging level of the first spacers 30a can be further lowered also because of the aforesaid effect that is obtained as the voltage applied to the grid 24 is higher than the voltage applied to the faceplate 10. Thus, the color purity can be improved further, and the surface treatment of the first spacers can be obviated or simplified.

This invention is not limited to the embodiment described above, and various modifications may be effected therein without departing from the scope of the invention. For example, the spacer forming material is not limited to the aforementioned glass paste, and may be suitably selected as required. Further, the diameters and heights of the spacers and the dimensions, materials, etc. of the other components may be suitably selected as required. The materials of the high-resistance films on the grid surface are not limited to tin oxide and antimony oxide, and they may be suitably selected as required.

The electron sources are not limited to the electron emitting elements of the surface-conduction type, and may be selected from various types including the field-emission type, carbon nanotubes, etc. Further, this invention is not limited to the aforementioned SED and may be also applied to an FED, an alternative type. Although the voltages from the two independent voltage supply units are applied to the faceplate and the grid, individually, according to the embodiment described above, voltage from a common voltage supply unit may be supplied instead.

What is claimed is:

1. An image display device comprising:
a first substrate having an image display surface;
a second substrate opposed to the first substrate across a gap and having a plurality of electron sources which excite the image display surface;
a grid provided between the first and second substrates and having a plurality of beam passage apertures opposed to the electron sources, individually;
a plurality of spacers which maintain the space between the first substrate and the second substrate; and
a voltage supply unit which applies a voltage to the first substrate and applies a voltage higher than the one for the first substrate to the grid.

2. An image display device according to claim 1, wherein the grid has a first surface opposed to the first substrate and a second surface opposed to the second substrate, and the spacers includes a plurality of columnar first spacers set up on the first surface of the grid and abutting against the first substrate and a plurality of columnar second spacers set up on the second surface of the grid and abutting against the second substrate.

3. An image display device according to claim 2, wherein each of the first spacers is set up on the first surface of the grid between the beam passage apertures, and each of the second spacers is set up on the second surface of the grid between the beam passage apertures and aligned with the first spacer.

4. An image display device according to claim 2, wherein the first spacers are shorter than the second spacers in height.

5. An image display device according to claim 2, wherein each of the first spacers abuts against the first substrate across a height correcting layer.

6. An image display device according to claim 5, wherein the height correcting layer has a resistance lower than that of the spacers.

7. An image display device according to claim 2, wherein the second spacers have a surface resistance lower than the surface resistance of the first spacers.

8. An image display device according to claim 1, wherein the surface of the grid and the inner surface of each beam passage apertures are subjected to high-resistance surface treatment.

9. An image display device according to claim 1, wherein the voltage applied to the grid is set within 1.5 times as high as the voltage applied to the first substrate.
